(19) United States
(12) Patent Application Publication
(10) Pub. No.: US 2012/0017161 A1
(43) Pub. Date: Jan. 19, 2012

(54) SYSTEM AND METHOD FOR USER INTERFACE

(76) Inventor: David Hirshberg, Haifa (IL)

(21) Appl. No.: 12/838,505

(22) Filed: Jul. 19, 2010

(51) Int. Cl. G06F 3/048

(52) U.S. Cl. 715/763; 715/762

(57) ABSTRACT

A text entry system for an electronic device comprising: (a) a text entry software engine receiving an interface description; (b) a server subsystem for storing a database of said interface descriptions; and (c) interface design tools providing a mean for interface designers to create said interface description. Condition upon the interface description the engine realize a text entry user interface by displaying objects on the device's screen, interrupting user input operations to text and send the text entered by the user to an application. A preferred interface description is selected and downloaded from a server to the device and used by the engine. Interface descriptions are created by the interface design tools are uploaded and stored in the database.

### FIELD AND BACKGROUND OF THE INVENTION

The present invention, in some embodiments thereof, relates to a user interface to electronic devices and, more particularly, but not exclusively, to a text entry system and method for hand held devices incorporating a touch screen. With the increasing popularity of mobile electronic devices, there has been a growing number of text entry interfaces suggested and implemented on the market. Many devices today use virtual keyboards implemented on systems incorporating a touch screen. A quit comprehensive overview of virtual keyboards as well as other text entry methods can be found in U.S. patent application Ser. No. 11/222,091 filed on 7 Sep. 2005 by Mita Das, entitled “FLUENT USER INTERFACE FOR TEXT ENTRY ON TOUCH-SENSITIVE DISPLAY” which is incorporated herein by reference.

Although virtual text entry keyboards may take a diverse variety of layouts and forms, commonly the user has very limited options when it comes to selecting or modifying the text entry virtual keyboard. These limitations imposed by the device manufacturer, the operating system, or the specific virtual keyboard/text entry application installed in the user's device. The present invention addresses the issues of choosing and customizing of text entry user interface methods in an electronic device.

### SUMMARY OF THE INVENTION

The present invention, in some embodiments thereof, relates to a user interface to electronic devices and, more particularly, but not exclusively, to a text entry system and method for hand held devices incorporating a touch screen.

According to an aspect of some embodiments of the present invention there is provided a text entry system for an electronic device comprising:

(a) a text entry software engine receiving an interface description and condition upon the interface description realizing a text entry user interface by displaying objects on the device's screen, interrupting user operations to text and send the text entered by the user to an applications running on the device;

(b) a server subsystem for storing a database of the interface descriptions; and

(c) interface design tools providing a mean for an interface designers to create the interface description; wherein a preferred interface description that is selected by the user is downloaded from the server subsystem to the device and used by the text entry software engine and wherein the interface descriptions created by the interface designers are uploaded and stored in the database on the server subsystem.

According to some embodiments of the invention, the system comprising a plurality of the text entry software engines each supporting different device platform.

According to some embodiments of the invention, the text entry software engine support plurality of the interface description installed in the device and enable selecting and switching between interface descriptions.

According to some embodiments of the invention, each of the interface description defines plurality of interface screens and for each interface screen the interface description defines plurality of parameters including at least one of interface screen location, size, geometry and/or appearance.

According to some embodiments of the invention, the interface description defines plurality of regions on a touch screen designated as keys and for each key defines plurality of parameters including at least one of key location, key size, key geometry, key appearance, key labels and/or key functions.

According to some embodiments of the invention, the interface description defines multi-functional keys and defines plurality of activation methods and activation functions to the multi-functional keys.

According to some embodiments of the invention, the interface description defines plurality of gesture shapes and for each of the gesture shapes defines plurality of parameters that identify the gesture and activation function associated with detection of the gesture.

According to some embodiments of the invention, the interface description defines multi segments gestures and for each segment defines plurality of parameters that identify the segment and activation function associated with detection of the gesture segment.

According to some embodiments of the invention, the system support text prediction and text completion.

According to some embodiments of the invention, the interface description format is a plurality of text and image files.

According to some embodiments of the invention, the server subsystem is a website hosting server and the services of the server are provided using web browsing interface.

According to some embodiments of the invention, the server subsystem contains for each the interface description in the database a statistics on the number of downloads, screenshots, documentation and the users rating, remarks and comments on the interface description.

According to some embodiments of the invention, the interface design tools include an applet that is downloaded from the server subsystem, runs on a web browser and enables designing and storing of a new interface description in the interface description database.

According to some embodiments of the invention, the interface design tools include a GUI base design tool wherein the design tool manipulates objects including at least key, keyboards, gestures are set, dragged and dropped, and the design tool generate the interface description according to a set of the objects created and edited by the design tool.

According to an aspect of some embodiments of the present invention there is provided a method for text entry for an electronic device comprising:

(a) an interface description stored on the device containing a text entry software engine that receives the interface description and condition upon the interface description realizing a text entry user interface by displaying objects on the device's screen, interrupting user input operations to text and send the text entered by the user to an applications running on the device;

(b) a database of the interface descriptions stored on a server subsystem; and

(c) interface design tools providing a mean for an interface designers to create the interface description; wherein a preferred interface description that is selected by the user is downloaded from the database to the device and used by the text entry software engine to provide text entry user interface to the user and wherein the interface descriptions created by the interface designers are uploaded and stored in the database on the server subsystem.

According to some embodiments of the invention, the method support plurality of the interface description installed in the device and enable selecting and switching between active interface description.

According to some embodiments of the invention, each of the interface description defines plurality of interface screens and for each interface screen the interface description defines plurality of parameters including at least one of interface screen location, size, geometry and/or appearance.

According to some embodiments of the invention, the interface description defines plurality of regions on a touch screen designated as keys and for each key defines plurality of parameters including at least one of key location, key size, key geometry, key appearance, key labels and/or key functions.

According to some embodiments of the invention, the interface description defines multi-functional keys and defines plurality of activation methods and activation functions to the multi-functional keys.

According to some embodiments of the invention, the interface description defines plurality of gesture shapes and for each of the gesture shapes defines plurality of parameters that identify the gesture and activation function associated with detection of the gesture.

According to some embodiments of the invention, the interface description defines multi segments gestures and for each segment defines plurality of parameters that identify the segment and activation function associated with detection of the gesture segment.

According to some embodiments of the invention, the method is used in conjunction with text prediction and text completion.

According to some embodiments of the invention, the interface description format is a plurality of text and image files.

According to some embodiments of the invention, the database contains for each the interface description statistics on the number of downloads, screenshots, documentation, user's rating and user's remarks and comments on the interface description.

According to some embodiments of the invention, wherein the interface description is downloaded, uploaded and rated using a website.

According to some embodiments of the invention, the interface design tools include an applet that is downloaded and runs on a web browser and enables designing and storing of a new interface description in the interface description database.

According to some embodiments of the invention, the interface design tools include a GUI base design tool wherein the design tool manipulates objects including at least key, keyboards and gestures that are created, set, dragged and dropped, and the design tool generates the interface description according to a set of the objects created and edited by the design tool.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of the electronic device, in accordance with a preferred embodiment of the invention;

FIG. 2 is a simplified block diagram of the server subsystem, in accordance with a preferred embodiment of the invention;

FIG. 3 is a simplified block diagram of interface design terminal, in accordance with a preferred embodiment of the invention;

FIG. 4 simplified block diagram of the full text entry system, in accordance with a preferred embodiment of the invention;

FIG. 5 is an illustration of a simple QWERTY keyboard interface description according to exemplary embodiments of the present invention;

FIG. 6 is an illustration of a double letter French AZERTY keyboard interface description according to exemplary embodiments of the present invention;

FIG. 7 is an illustration of a ten way key based numeric keyboard interface description according to exemplary embodiments of the present invention;

FIG. 8 is an illustration of an extra symbol keyboard interface description according to exemplary embodiments of the present invention;

FIG. 9 is an illustration of the server home page according to exemplary embodiments of the present invention;

FIG. 10 is an illustration of the setting screen of the text entry software engine according to exemplary embodiments of the present invention; and

FIG. 11 is an illustration of screen of a GUI based interface description editor according to exemplary embodiments of the present invention.

### DESCRIPTION OF SPECIFIC EMBODIMENTS OF THE INVENTION

The present invention, in some embodiments thereof, relates to a user interface to electronic devices and, more particularly, but not exclusively, to a text entry system and method for hand held devices incorporating a touch screen. Popular hand held devices today incorporate a touch screen. In those devices text entry is performed by a virtual keyboard that pops up when the user selects an editable text field. In many cases, for example in iPhone, the manufacturer is limiting the user to use the built-in text entry method. In other cases, like Windows Mobile or Google Android devices, the user can install alternative text entry components. In some cases the user has some freedom to choose different layouts, different styles and different languages but the selection and customization is very limited and tedious.

The current invention presents a new concept of flexible text entry system that breaks the dependency between the text entry software application and the text entry interface method by introducing a component that on one hand is tightly integrated into the device's operation system and on the other is linked to a system that provides the freedom to create and choose wide variety of text entry interface methods and styles.

With the aid of a communication network a simple and intuitive management of the choices is achieved. In addition, the invention concept provides a way to unify text entry in different device types and platforms and allows a cross platform text entry solution.

As used herein, the term/phrase device means any electronic devices using a touch screen and providing a text entry means such as cellular phones, game consoles, audio or video players, Personal Digital Assistants, computers, laptops and tablet computers or any other user operated electronic device.

The term/phrase text entry software means any software component running on the device that receives the user input operations and interprets those inputs operations to text.

The term/phrase network means any communication means that connect the device to an infrastructure that provide text entry method interface description to the device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

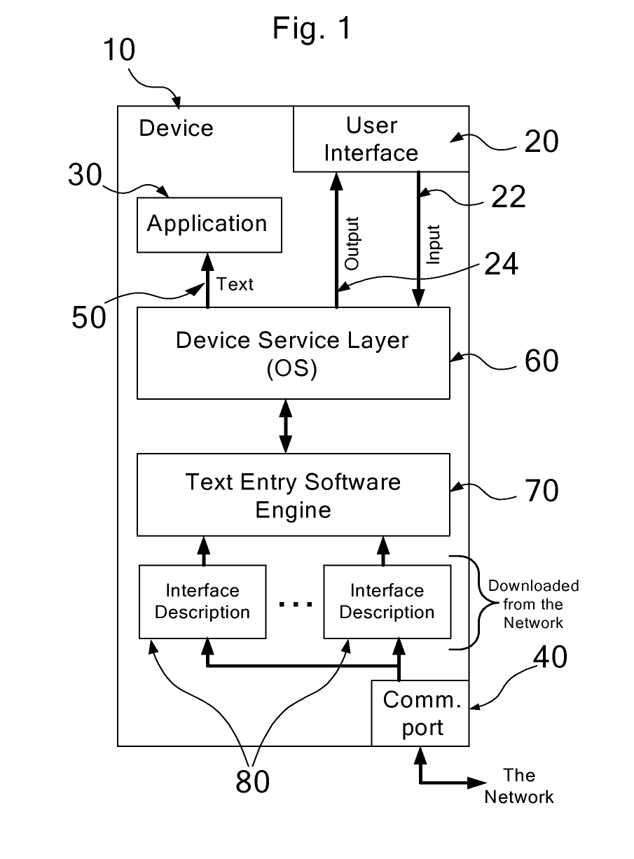

For purposes of general understanding embodiments of the present invention, reference is first made to an abstract simplified block diagram of a device according to the invention as illustrated in FIG. 1. In the Figure, a device 10 comprising a user interface means 20 including a touch screen. Device 10 comprises of an application 30 that receives some text entry inputs from the user. Device 10 contains a device service layer 60, usually is being referred also as an operating system, which manages all activities in the device in general, and user interface inputs 22 and user interface outputs 24 in particular.

Whenever an application 30 needs a text entry 50 from the user, a device service layer 60 activates a text entry software engine 70. Text entry software engine 70 is capable of providing variety types and styles of user interface methods to enter text. The variety types are stored in independent interface descriptions 80. Interface descriptions 80 are downloaded from the network by the user. Interface description 80 contains all the information that allows engine 70 to display the specified user interface objects on the screen and to interrupts user interface inputs 22, such as finger touches and swipes over the touch screen, in order to provide a text entry 50 to application 30.

Device 10 may store many interface descriptions 80, which are downloaded via a communication port 40. The user can decide which interface description 80 will be the default interface the user will use whenever a text entry input is needed. The user can navigate between interface descriptions 80 and simply and immediately select in any time to use any one of interface descriptions 80 that are stored in device 10. For the sake of clarity, FIG. 1 illustrates only the essential parts in the device needed to describe the invention and does not include all other necessary and optional components in device 10 such as processors, communication means and other software and hardware components.

As used herein, the term/phrase text entry software engine or in short the engine means any software component implemented in variety of software architectures and programming languages that receive the user operations and interrupt them to text entry according to interface descriptions.

As used herein, the term/phrase interface description, which is also being referred as a keyboard or a layout or a skin or a design set, is any storable object or set of objects in the device such as files or memory elements or system resources that contain an information or description to be used to implement a specific text entry method.

As used herein, the term/phrase text entry user interface means any set of rules and methods that are used to translate user input operations to text entry elements such as letters, characters, symbols, words and any additional functions related to the text entry system operation.

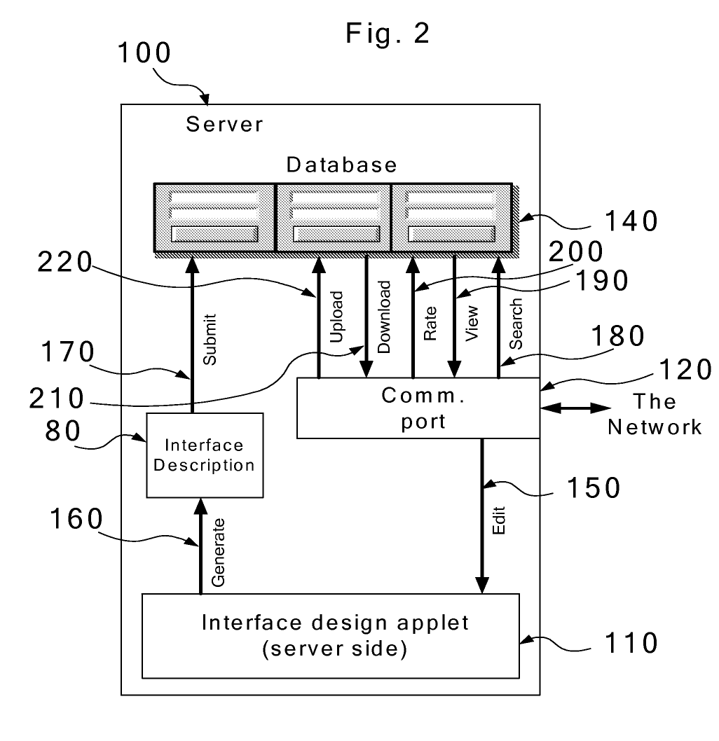

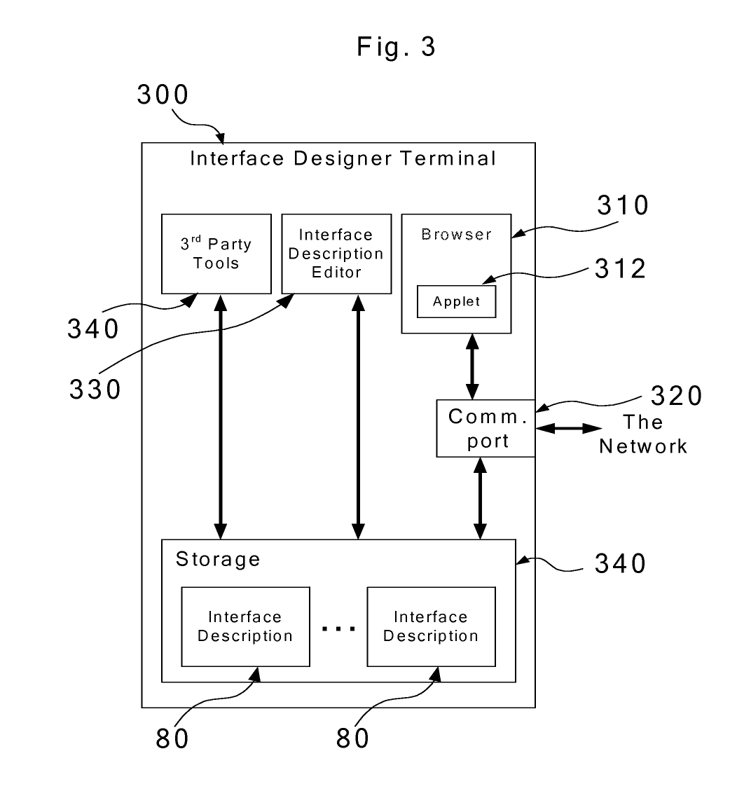

Reference is now made to FIG. 2 which illustrates a simplified architecture for a server side of the text entry system. A server 100 provides, via a communication port 120, services for both users having devices with text entry software engines illustrated in FIG. 1, and for text entry user interface designers having a design terminal illustrated in FIG. 3. Although for the sake of clarity server 100, illustrated in FIG. 2, is centralized the services illustrated in FIG. 2 may be implemented in a distributed fashion as well. Server 100 contains a server side of an interface design tool applet 110. The server side of interface design tool applet 110, together with an applet 312 running inside a browser in an interface designer terminal (shown in FIG. 3), enables creation and editing 150 of interface descriptions 80.

Any user can become an interface designer who specifies the contents as well as the look and feel of the user interface. The designer specifies key sizes, layout, colors and graphical style as well as the type of the user interface. The type of interface includes features such as standard touch keys keyboard, directional activated keyboard, gesture based text entry methods or any other methods supported by the engine. When interface designer finishes specifying the text entry user interface, applet 110 generates 160 a suitable interface description 80. Interface description 80 is submitted 170 to a database 140. Many partitions between client side applet 312 (shown in FIG. 3) and server side applet 110 are possible. On one hand a partition where all processing, including interface description 80 generation, is done on client side applet 312 is possible, on the other hand a partition where the applet serves just as a user interface mediator to server side applet 110 is also possible. Any partition in between those to extremes is possible as well.

Database 140 contains a plurality of interface descriptions 80. Interface descriptions 80 in database 140 differ in graphical styles, interface methods, layouts, languages, the creating designers, etc. Server 100 provides for the users the ability to search 180 the database 140. Search can be done with variety of query parameters to find the specific interface description 80 the user is looking for. The user can view 190 the interface description 80 appearance and documentation and can download 210 the selected interface description 80 to his device. Server 100 manages statistics of the downloaded interface descriptions 80 and provides the user with tools to rate and comment 200 interface descriptions 80 in database 140. Interface descriptions 80 that have been generated outside server 100 can be uploaded 220 by the text entry interface designer to the database.

As used herein, the term/phrase server subsystem, or in short server, means any computing facility or facilities such as web hosting, cloud computing infrastructure or any other means that provide data storage, communication and client server type of services.

Reference is now made to FIG. 3 which illustrates an abstract block diagram of an interface designer terminal. Any user that wishes to create a new interface description 80 can become an interface designer. An Interface designer terminal 300 is the apparatus used by the interface designer to create and edit interface descriptions. The interface designer terminal 300 can be any device that is able to connect to server 100. Typically it will be a personal computer (PC) but any type of computing device including the one running the text entry software engine 70 illustrated in FIG. 1 is a valid interface designer terminal 300. Interface designer terminal 300 purpose is to design new interface descriptions 80. The interface designer can make new interface descriptions 80 in one of the following ways:

(1) using a browser 310 and connecting to the server 100 (sown in FIG. 2);
(2) using an interface description editor 330; or
(3) using a 3^{rd} party tools 340.

When the interface designer wishes to edits the interface descriptions 80 using browser 310, an applet 312 is downloaded from the server using communication port 320 and the interface designer create and edit a new interface description 80 using applet 312 running inside the browser. Interface description 80 may be automatically generated and submitted to the server's database. When the interface designer edits interface descriptions 80 using interface description editor 330, editor application 330 is running on the local terminal and generate new interface description 80 in a local terminal storage 340. Generated interface description 80 may then be uploaded to the server. The interface description 80 may be stored in many different formats, one of the most convenient one is a set of plain text and image files. In this case interface description 80 can be easily generated by a standard 3^{rd} party tools such as text editors and graphic tools.

As used herein, the term/phrase interface design tool means any combination of software components that enables creation, editing and generation of interface descriptions. Interface design tool may come in different flavors and computing environments and in different embodiments of the current invention and is being also referred herein as interface description editor, interface design applet or in short applet, design application, design tool, design editor, or 3^{rd} party editor or tool.

As used herein, the term/phrase interface designer means any person or entity that creating new interface description.

As used herein, the term/phrase interface designer terminal means any apparatus used by the interface designer to create new interface description.

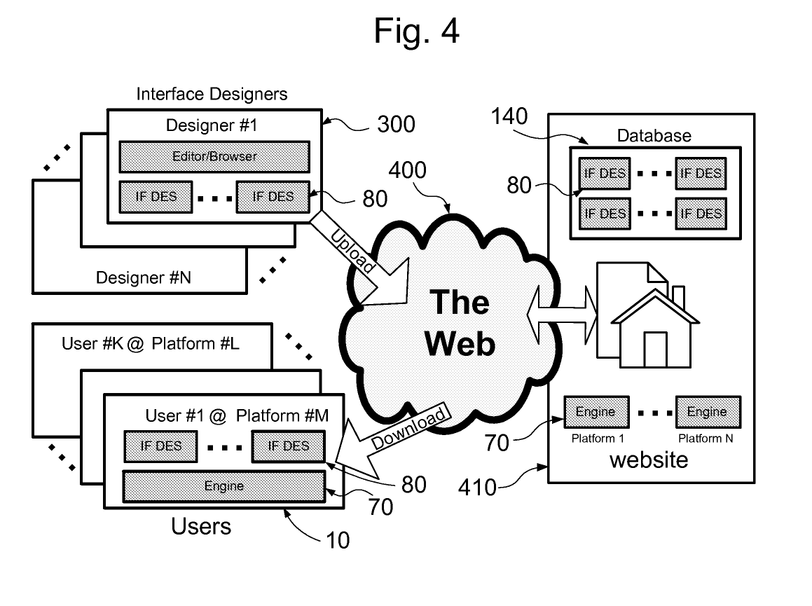

Reference is now made to FIG. 4 which illustrates an embodiment of the complete text entry ecosystem. The network that connects the components of the text entry system is the World Wide Web 400. The ecosystem includes a plurality of users each using a device 10, a plurality of interface designer each using an interface designer terminal 300 and a server located in a website hosting 410.

The devices 10 may belong to different platforms. The term/phrase platform means a class of devices possibly from different product models and different manufacturers that can run the same version of the text entry software engine 70. Typically those will be devices that run the same operating system. The text entry system is a cross platform system and the same interface description 80 can be used on different platforms. For each supported platform there is a suitable version of engine 70 and the user can download the appropriate engine from website 410. The version of the engine may be downloaded and installed from other websites on the web as well as from official web stores of the specific platform, e.g. Apple AppStore and Google Market. Text entry software engine 70 can be already installed in the device prior to the device sale or bought in a store afterwards.

Users can download interface description 80 form website 410 using database 140 quarries as well as utilizing rating, download statistics, user's comments and other utilities that exist on website 410 in particular and in the web in general. Interface description 80 may be available for users in other web sites or locations on the web or directly shared between users by a peer to peer communication.

The interface description 80 database is continuously updated with new interface descriptions 80 made by the interface designer community. The interface designers create new designs using the interface designer terminals 300. Interface description 80 are uploaded and stored in database 140 on web site 410. Interface descriptions 80 as well as text entry software engine 70 may be delivered freely or may be sold commercially. A business model where a free usage is given to the users while commercial ads are provided may be used as well.

### EXAMPLES

Reference is now made to the following examples, which together with the above descriptions illustrate some embodiments of the invention in a non limiting fashion.

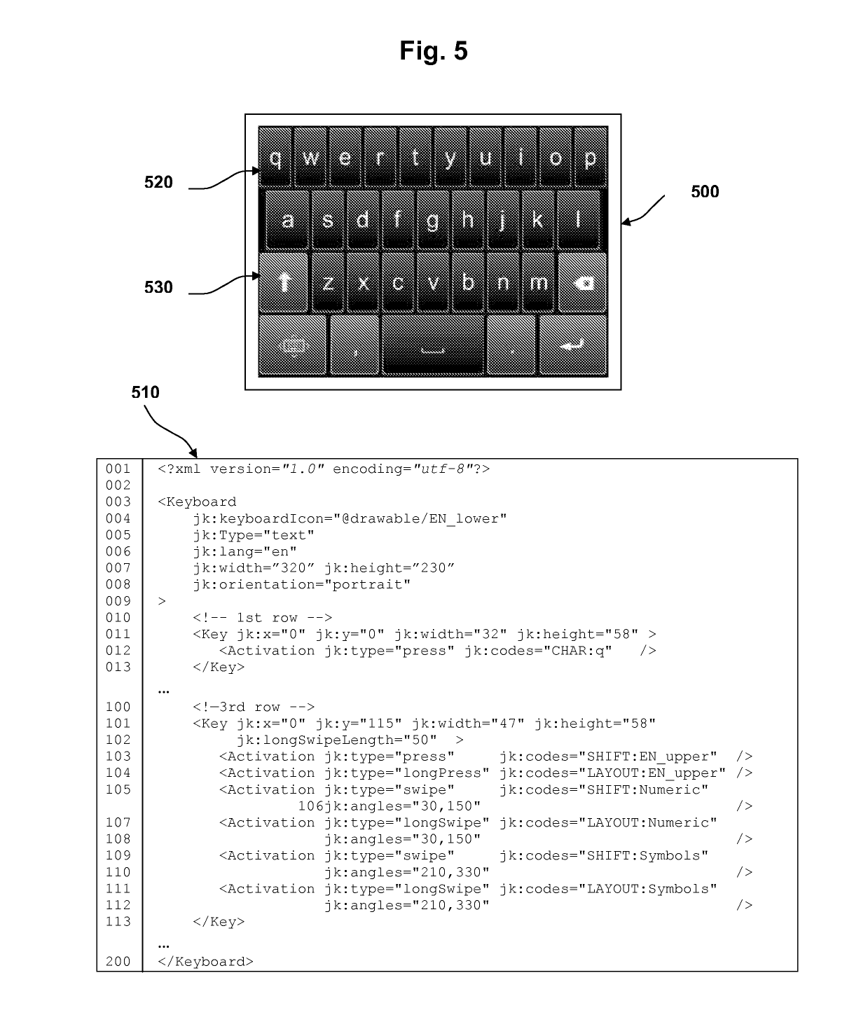

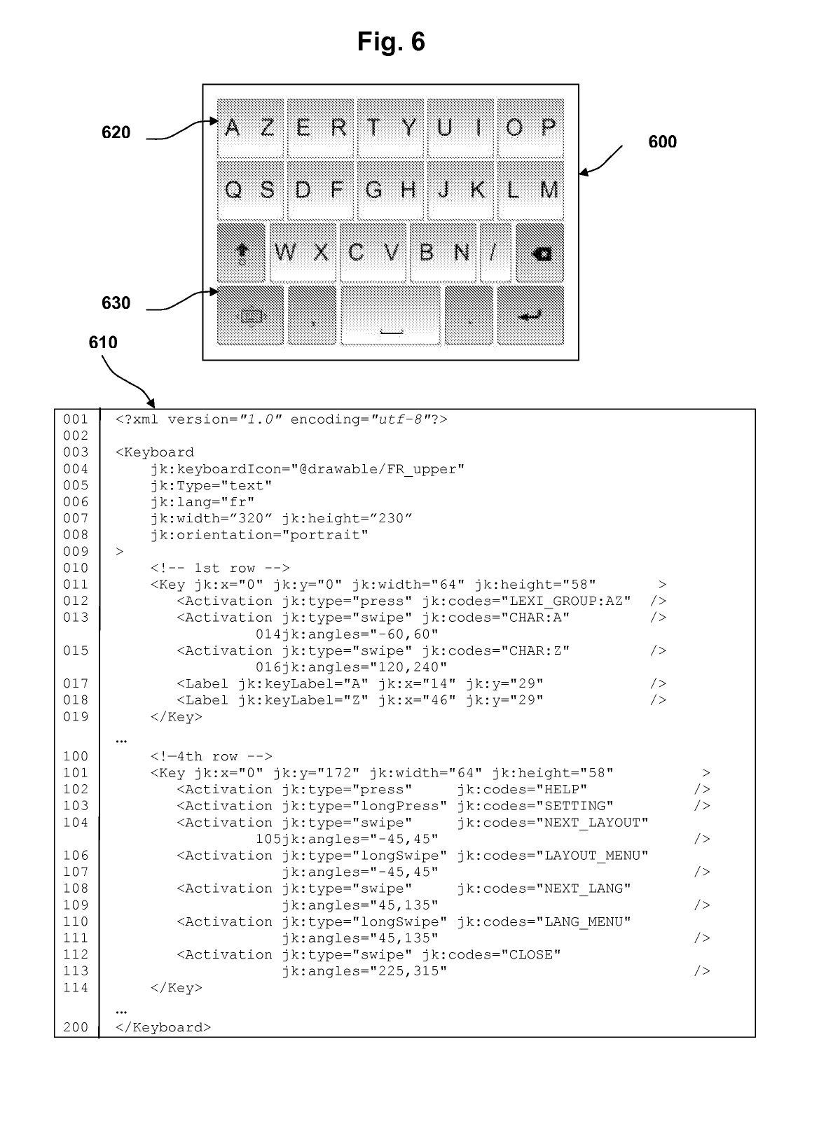

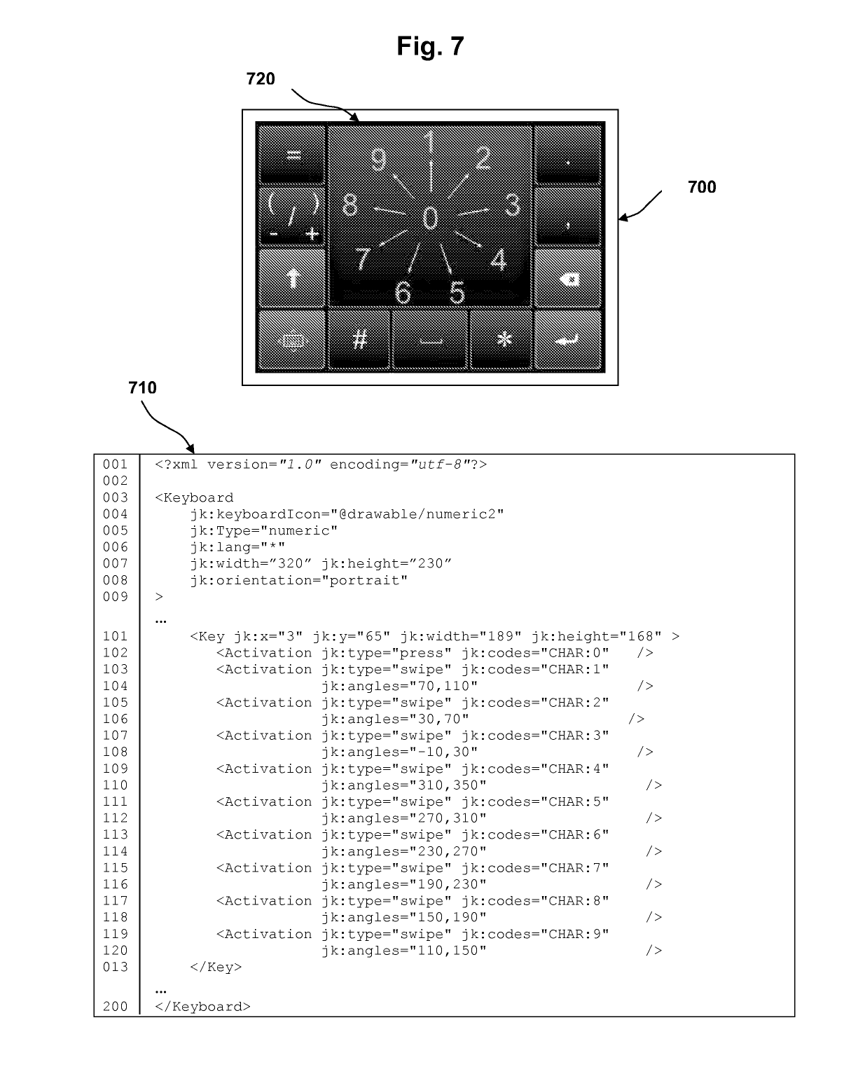

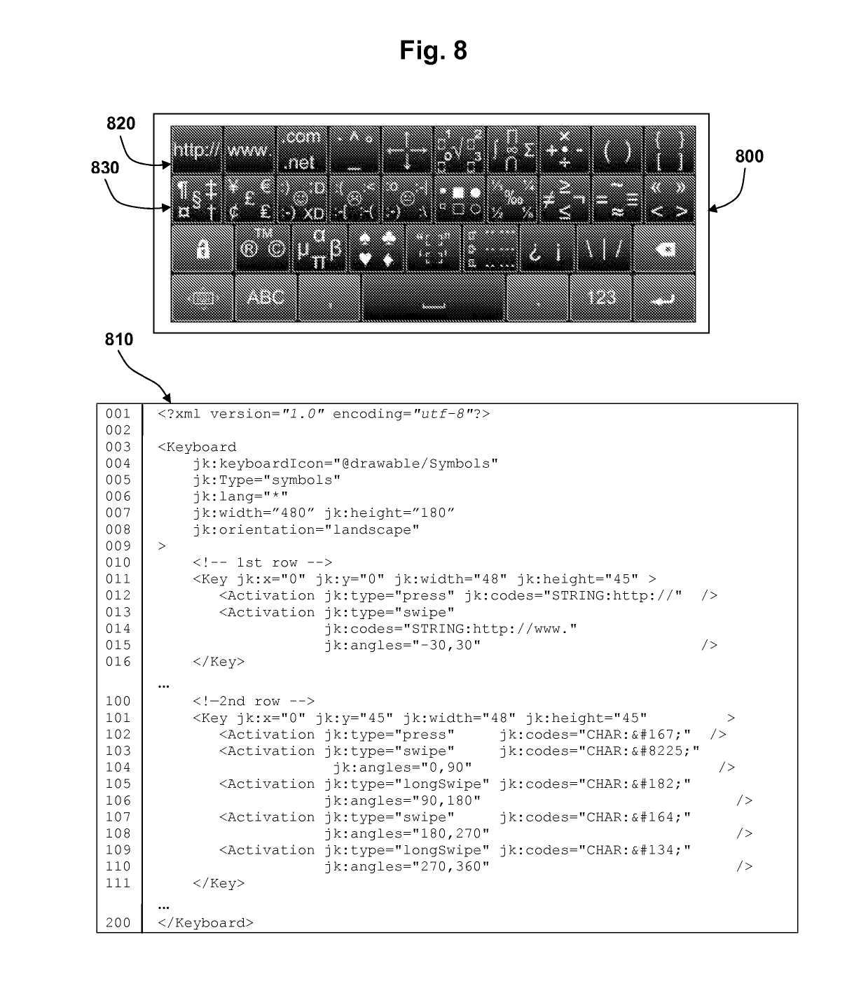

FIGS. 5-11 and the following description provide, for clarity, a limited scope of detailed example of embodiment of the invention. In the following embodiment a customizable layout, keyboard based, text entry interface is demonstrated. The interface description enables to describe different type of layouts of keyboards with different type of keys. FIG. 5 illustrates a standard QWERTY layout keyboard where most of the keys activated by simple press operation, FIG. 6 illustrates French language layout wherein for the letters keys a pair of letters are associated with a single key. FIG. 7 illustrates another layout defined by an interface description. In this case, a keyboard designed for numeric data entry is provided. FIG. 8 illustrates yet another layout for a device in landscape display mode. This keyboard layout is designed to enter special symbols. All layouts in FIGS. 5-8 are displayed and processed with the same text entry software engine using different interface descriptions. Those interface descriptions are loaded to the device, read by the text entry software engine and provide different types of text entry user interface. In the following section a detailed description of an example of a specific format implementation of the interface description with respect to the FIG. 5-8 is given.

Reference is now made to FIG. 5 which illustrates a standard QWERTY layout keyboard. A keyboard layout 500, as shown on device screen, comprising of 26 Latin letter keys located in the three top rows and additional 7 keys located in rows 3 and 4. The interface description for layout 500 comprises of two files: a text file in XML format where a partial listing 510 is presented in the bottom part of FIG. 5, and an image file named “EN_lower” contains the graphic appearance of the layout. Line 001 of the interface description XML file 510 contains standard XML header. Lines 003-009 contains some keyboard attributes. Line 004 is a reference pointing the engine to the image file “EN_lower”. Image file can be in any standard format such as: PNG, JPEG, bitmap, TIFF, etc. Line 005 informs the engine that this layout is used for text entry. Line 006 informs the engine that this layout is used for enter text in English. Line 007 informs the engine of the size of the keyboard 500, in this case 320 by 230 pixels. Line 008 informs the engine that this keyboard should be used when the device is in a portrait display mode. For the sake of clarity in the following examples all sizes and location will be measured in absolute pixels however in general the engine and the interface description supports dynamics size keyboards wherein the size and location parameters are given in relative units. In this case the keyboard interface definition may be used in different screen size, different screen orientation as well as adapt to dynamic change of the keyboard by the user.

Lines 011-013 describe the top left key 520. Key 520 is used to enter the letter ‘q’. In order to inform that to the engine, line 012 defines the activation type as press and the activation code as the character ‘q’. Previous line, line 011, defines the location and size of the key. Other keys of the keyboard are defined in similar manner.

Listing 510 also elaborate the description of key 530. Key 530 is used to switch between lower case keyboard and an upper case keyboard. In addition, in this example, the interface designer chose to use this key for several others layout switching operations. Line 101 defines the key location and size. Line 102 defines a parameter for the engine that used to distinguish between two types of activation methods: swipe and long swipe. When applied here the parameter scope is only for the current key. Any parameter, as for example “longSwipeLength”, can be defined in any place in the hierarchy starting from the default engine setting going through a layouts family and a specific layout and ending in a specific key setting. Any setting in the lower part of the hierarchy overrides the upper settings.

Lines 103-112 define 6 activation types for the key. Line 103 defines that simple press on the key will shift to layout “EN_upper”. By stating shift in this case it means that the layout will be switched back to layout “EN_lower” after typing one capital letter. In the case of this example, if the user would like to switch to the upper case layout for more then one character entry the user must make long press on key 530. Line 104 describes this functionality. In line 104 a long press activation is declared with activation code “LAYOUT:EN_upper”. This syntax informs the engine to switch to layout “EN_upper” without switching back after one character inputting. The time that the engine waits until detecting long press is a parameter named “longPressTime”. Since it is not defined in the key nor in the keyboard a default value will be taken by the engine.

The layout “EN_upper” is another keyboard layout designed by the interface designer. EN_upper is a layout in the same layout family. Layout family is a set of layouts installed together into the engine and is referred also as skin or design set. Engine can switch between layouts or interface descriptions that are not in the same family. There are several ways to do some of them will be disclosed later. The simplest way is to explicitly state the layout with the format LAYOUT:<layout_family_name>/<layout_name>.

Key 530 is also used to switch to other layouts such as numeric layout and extra symbols layout. Line 105-106 defines a swipe activation type. Swipe activation is an activation wherein the user touch a key then swipe its finger from the key outwards to any direction. Plurality of swipe activations can be applied to a single key differentiated by the range of angels the swipe is made. Line 105-106 define that for angle range between 30 to 150, i.e. swiping upwards the engine will shift, i.e. for one digit entry, to a new layout, a numeric layout. Lines 107-108 inform the engine to switch to the numeric layout if a long swipe to the same direction is performed by the user. Lines 109-112 define similar operation for swiping down. In this case another layout, used to enter extra symbols is opened for one symbol entry when short swipe was made and for multiple symbols entry when long swipe was made. Line 113 indicates end of definitions for key 530. Line 200 ends keyboard definition after all keys in the keyboard are defined.

Reference is now made to FIG. 6 which illustrates a French language AZERTY layout. Keyboard 600 comprises of letters keys wherein pairs of letters are associated with each letter key. The interface description XML file listing 610 elaborates the definition of key 620 and key 630. Line 003-009 defines the keyboard parameters as in the keyboard illustrated in FIG. 5, however line 006 inform the engine that this keyboard is intended for entering French text. Line 004 referring to the image file “FR_upper”. The keyboard graphic style of this layout is different in this case, instead of white labels over a dark background, a black labels over a bright background is used. The graphic style is incorporated in the images file. Any colors backgrounds and key shapes and labeling may be defined.

Key 620 is twice as wide as a standard AZERTY keyboard key hence easier to select. Lines 011-018 describe the key. Line 11 defines the size and location. Lines 013-016 define swipe left and swipe right activation type to enter the letters A and Z respectively. When the user performs simple press on the key the group of the letters A and Z is submitted to lexicographical text prediction and completion system. Since the layout is French layout the text prediction system will use French dictionary. The functionality of the press operation is defined in line 12. Line 017 and 018 demonstrate alternative option to label the key. In this case the label of the key is not part of the key image but it is created on the fly by the engine. A key can have as many labels as needed. In this example two are defined. Each label has a location relative to the key edge. An advantage of using labels is that it saves images size by defining a single key image and use the same image to create many different keys.

Key 630 is defined in lines 101 to 114. Key 630 is used to perform several control functions on the keyboard 600, if the user press on the key an inline help screen describing the keyboard is popped-up. This is defined in line 102 using the activation code “HELP”. If a long press is applied to the key a setting screen is popped up as defined in line 103.

Swiping right allow the user to switch to another keyboard layout. Short swipe will switch to the next layout while swipe long will open a pop up menu contains all available layouts in the engine and enables the user to switch to the selected layout. This functionality is defined by lines 104-107.

Lines 108-111 define the swipe up operations. Short swipe up perform a switch to a layout that support the next available language in the engine while long swipe up opens a pop up menu with all the languages supported by the keyboard.

Lines 112-113 define the swipe down operations. Swipe down close the keyboard.

Reference is now made to FIG. 7 which illustrates a layout designed for numeric date entry. Keyboard 700 contains a primary ten functions multi-functional key 720 to enter the 0-9 digits. The key is activated by 9 directional swipes for the digit 1-9 and a press for the digit 0. The interface description XML file 710 elaborates the definition of key 720 in lines 101-120. Line 004 refers to the image file the keyboard appearance is taken from. Line 005 inform the engine that this is numeric keyboard and whenever the OS in the device explicitly tells the engine that the edited field accept only numeric values the engine will automatically open a numeric layout. Line 6 informs the engine that this layout is applicable to all languages. Key 720 demonstrate the flexibility the interface designer has in designing layouts and keys with any size, location and functionality.

Reference is now made to FIG. 8 which illustrates a layout designed for symbols date entry. Keyboard 800 contains 36 keys. Key 820 and key 830 definitions are elaborated in interface description XML file partial listing 810. Line 005 informs the engine that layout 800 is symbol type layout and line 006 informs the engine that the layout is applicable for all languages. Line 007 defines the size of the keyboard that is fitted to landscape mode view define by line 008.

Key 820 is defined in lines 011-016. The key function is entering the string “http://” when the key is pressed and the string “http://www.” when swipe right operation is performed. This is done by the “STRING” activation code.

Key 830 is defined in lines 101-111. The key has five functions, one when key is pressed and the other four when swiping to 45°, 135°, 225° and 315° respectively. The definition of this key reveals the format of providing explicitly the symbol Unicode value in the activation code attribute.

FIGS. 5-8 provide only a brief example for the implementation of interface description. The actual format is much richer and includes support for many more features. Although only a concept of describing layouts and multi functional keys were demonstrated many other text entry user interfaces described in similar way.

In accordance with an exemplary embodiment of the invention, several layouts are bundled and packaged in a single installable interface description, being referred hereafter also as interface description design set or just design set.

In accordance with an exemplary embodiment of the invention, design set is managed in a standard file system as a directory. The design set name is the name of the directory. General definition of the set is stored in XML file format in the same directory and the design set layouts is stored in ‘layout/’ subdirectory. The image files is stored in ‘drawable/’ subdirectory and documentation is stored in ‘help/’ subdirectory.

In accordance with an exemplary embodiment of the invention, information such as version and creator and other attributes of the layout are stored in the design set files.

In accordance with an exemplary embodiment of the invention, the interface definition support keys with non rectangular shape. Additionally or alternatively, user interface appearance and layout may take any shape.

In accordance with an exemplary embodiment of the invention, key description includes a visual and auditory feedback description that controls the appearance and sound when activating the key in variety of events.

In accordance with an exemplary embodiment of the invention, keys have dynamic size and appearance based on a dynamic state managed by the engine.

In accordance with an exemplary embodiment of the invention, key activation includes multi-tap operations.

In accordance with an exemplary embodiment of the invention, gesture based activation is used. Additionally, interface description defines set of attributes for each type of gesture as well as associate activation code for each type of gesture. Additionally or alternatively, gesture detection interrupts hand writing recognition. Additionally or alternatively, gesture is define by plurality of segments and for each segment features like length, velocity, direction as well as derivative attribute are described in the interface description.

In accordance with an exemplary embodiment of the invention, a sequence of activation codes are detected during continuous single gesture. In this case, interface description specifies the activation code of each segment as well as defines the activation codes of starting and ending of the gesture.

In accordance with an exemplary embodiment of the invention, interface description semantics support a combination of activation method in a single keyboard appearance.

In accordance with an exemplary embodiment of the invention, activation codes include pop up keypads, menus, and variety types of switching commands between layouts and interface descriptions.

In accordance with an exemplary embodiment of the invention, conditional and unconditional command depended on the state and the history of user operation is provided. Additionally or alternatively, switch back to previous layout activation code is supported by the engine and the interface description.

In accordance with an exemplary embodiment of the invention, text prediction and text completion are supported by the text entry system. Additionally or alternatively, activation codes related to dictionary management are provided.

In accordance with an exemplary embodiment of the invention, learning the user operation history is supported. Additionally or alternatively, adding previously typed word is supported. Additionally or alternatively, learning and correcting typical user error is provided.

In accordance with an exemplary embodiment of the invention, engine is aware of the specific context of the text entry and selects the specific layout and/or interface description in accordance with the type of current editable field as well as to the specific application that calls the text entry software engine.

Many alternative interface description formats may be used including variety of text based formats and binary formats. Interface description can be partitioned, bundled and stored in variety of ways such as file system, database or any other data storage management scheme.

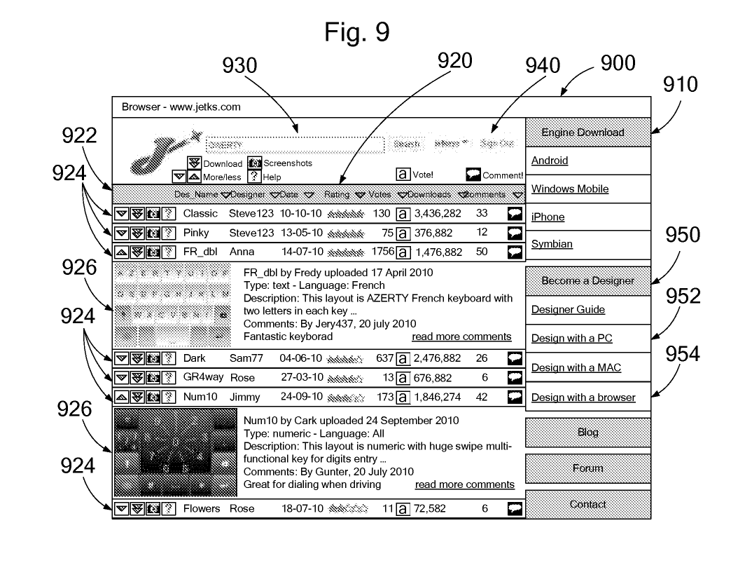

Reference is now made to FIG. 9 which illustrates a web page presented by the server subsystem. The page is displayed using a standard web browser display 900. The page contains pane to enable download of the text entry software engine to the devices 910. Multiple engines versions are available to support variety of platforms. The main design set list pane 920 contains a design set list with the available interface description in the server database. Design set list pane 920 comprises of header row 922, design set summary rows 924 and design set additional info boxes 926. Design set row 924 includes the following info: (1) design name, (2) designer name, (3) date of uploading the design set, (4) the rating of the design set, (5) the number of voters that rate the design, (6) number of users that download the design set to their device, and (7) the number of comments user posted on the design set. In addition six buttons exist on each element in the list: (1) More/less button used to open close additional info boxes 926, (2) download button to download the design set, i.e. the interface description, to the device, (3) screenshot button that open a screen with screen shout of the design set layouts, (4) help button that help the design set documentation and help, (5) vote button that opens the user's voting screen and comment button that opens the users commenting screen.

Design set additional info boxes 926 contains some additional info like the type and language of the interface description as well as a thumbnail of the first screenshot short description and last comment. A link for reading all comments is provided as well.

Header row 922 contain buttons adjacent of each column so user can sort the design sets with any parameters (sort by decrement rating is presented in FIG. 9). In addition the user can use a search box 930 to look for specific interface description design set. A logon/logout box 940 is also provided for user identification needed for voting and commenting as well as submitting new design set to the system.

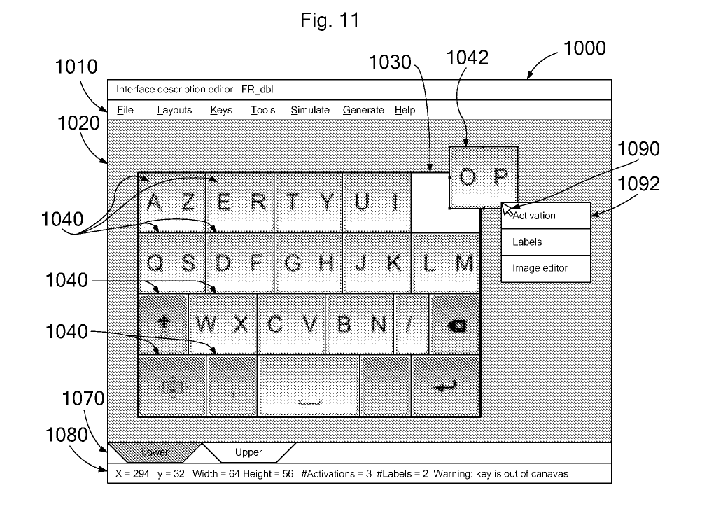

The designer pane 950 allows the user to become an interface designer. By clicking on link 952 the designer can download an interface description editor for a PC to easily design a new interface description. The PC interface description editor environment is illustrated in FIG. 11 and will be discussed later. Design tools for other environment such as for Macintosh may be available as well. Link 954 opens a new web page that runs an applet that enable designing of interface description inside the browser. The details of editing an interface description design set inside the browser is similar to the one that is done over a PC. Since the design set interface description comprises of XML text files and PNG image files the designer may also design new design sets using standard 3^{rd} party tools such as XML or text editor and image editing tools such as Photoshop.

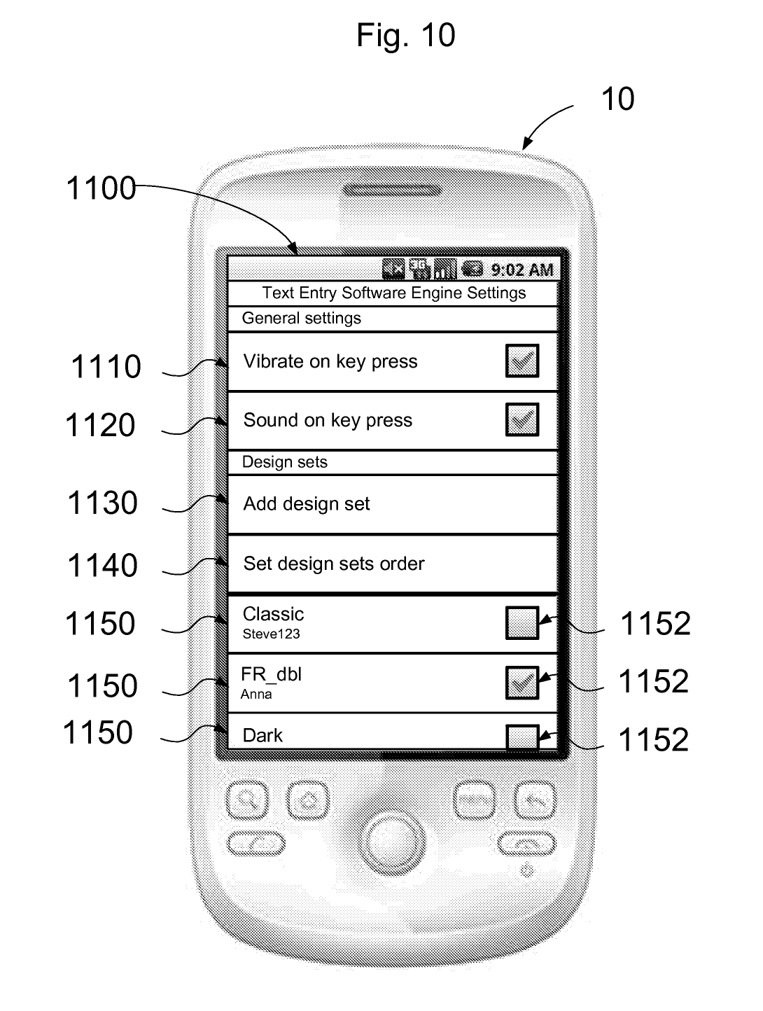

Reference is now made to FIG. 10 which illustrates a setting screen of the text entry software engine. Device 10 has a touch screen 1100. When the user enter the setting screen of the engine the touch screen 1100 display the screen illustrated in FIG. 10. The screen contains some general setting such as vibrate on key press 1110 and sound on key press 1120. Each one of those setting has a radio button that can enable or disable this feature. The engine enables the user to set and manage the interface description design sets used by the engine. Pressing the box 1130 will open a new screen that will display a user interface design set list similar to the one illustrated in FIG. 9. The list is received from the database in the server subsystem and displayed directly on the device in a convenient way adjusted to the device screen size. The user can directly select and install any one of the interface descriptions stored in the database. The interface descriptions that are already installed in the device are shown as a list of elements 1150 at the bottom of setting screen 1100. Each interface description can be enabled or disabled by touching on the respective radio button 1152. When the interface is enabled radio button 1152 will be checked.

Upon application request for text entry, the engine will open the first enabled interface description design set in the setting list. In the design set the engine open the default layout defined in the set. The user can switch to layouts in other design sets using several operations such as next and previous layout activation codes or via menus that display all enabled design sets. In order to change the default design set as well as the order of layouts in the next/previous layout switch operations, the user can change the orders of installed design set by selecting box 1140.

Reference is now made to FIG. 11 which illustrates a PC based interface design tool. An interface description editor GUI based screen 1000 contains a menu bar 1010. Menu bar 1010 contains File, Layouts, Keys, Tools, Simulate, Generate and Help submenus. File submenu is a standard common file operation menu such as open new design set, open existing design set, save design set, save a copy of the design set, etc. Layout submenu is used for commands that are related to the various layouts defined in the interface description design set. Command like open new layout, delete layout, reorder layouts and set layout parameters are presented in this menu. The current editable layout is presented in the layout tab 1070. In FIG. 11 there are two layouts in the design set: Lower and Upper. The active editable layout is ‘Upper’ layout. Keys submenu is used for commands related to keys including creating and deleting new keys as well as setting varies parameters of the keys. Simulate submenu is used for a simulation of the design set in various platform. The designer can select the platform to simulate the layout. Platform setup includes the screen size of the device. By using the PC mouse, the designer can simulate the finger touch operation over a touch screen and validate the behavior of the interface description design set and check immediately the correctness of his design. Generate submenu is used for generating the final interface description and upload the interface description either to the server's database or directly to the target device. Help submenu is used for receiving more information on the application and its usage.

Interface description editor screen 1000 contains an editing pane 1020 with a canvas 1030 that indicates the keyboard boundary on the device screen. The editing pane is a container with objects on it. In the current illustration only keys 1040 are located on the editing pane 1020. Other objects such as visual feedback objects, gesture tracker as well as any real or virtual object that operates during the text entry interface operation can be added to the editing pane 1020. Using the pointing device the designer can select one or more objects in the editing pane 1020. In FIG. 11 a key 1042 is selected. Key 142 can be drag and dropped using curser 1090 of the pointing device into any place in the editing pane 1020 and inside the canvas 1030. The properties of the active object are displayed in the status bar 1080. In case of key 1042 the status contains the location and size of the key, summary of its contents i.e. the number of activations and labels define for key 1042, and a warning message indicate that the key is not fully inside the canvas so it will not display properly on the device. Clicking on a selected object will pop up a menu 1092 enabling settings and operations on the object. In the case of key 1042 the designer can set activation, labels and open an image editor to change key appearance. Those operations can be selected using submenu ‘Keys’ in the menu bar 1010 as well.

A similar GUI approach is used for deigning a interface description design set in other environment such editing a design set inside a browser or in other computing environments. Other GUI concepts and editing tools can be used starting from a simple text based and pixel based editors to a sophisticated fully automated wizard tools.

The invention described herein suitable for implementing many types of techniques for text entry including, but not limited to, the text entry methods described in the following references:
(1) I. S. MacKenzie and S. X. Zhang, “The design and evaluation of a high-performance soft keyboard”, Proceedings of CHI'99: ACM Conference on Human Factors in Computing Systems, pp 25-31.
(2) J. Mankoff and G. D. Abowd, “Orrin: a word-level unistroke keyboard for pen input”, Proceedings of the 11th annual ACM symposium on User interface software and technology, pages 213-214, ACM, 1998.
(3) U.S. Pat. No. 5,959,629 filed on 12 Nov. 1997.
(4) U.S. Pat. No. 6,286,064 filed on 24 Jan. 1999.
(5) U.S. Pat. No. 6,816,859 filed on 9 Jul. 2001.
(6) U.S. Pat. No. 6,597,345 filed on 5 Nov. 2001.
(7) U.S. Pat. No. 6,847,706 filed on 10 Dec. 2001.
(8) U.S. Pat. No. 7,057,607 filed on 30 Jan. 2003.
(9) U.S. Pat. No. 7,320,111 filed on 1 Dec. 2004.
(10) U.S. patent application Ser. No. 10/617,296 filed on 10 Jul. 2003.
(11) U.S. patent application Ser. No. 11/222,091 filed on 7 Sep. 2005.
(12) U.S. patent application Ser. No. 11/774,578 filed on 7 Jul. 2007.

The above listed text entry methods as well as many others may be implemented as embodiments of the current invention text entry system. Current invention allow the user to efficiently choose and switch between methods and/or combine several methods together as well as simply redesign, customize and use text entry methods tailored to the user needs.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A text entry system for an electronic device comprising:
(a) a text entry software engine receiving an interface description and condition upon said interface description realizing a text entry user interface by displaying objects on the device's screen, interrupting user input operations to text and send the text entered by the user to an applications running on said device;
(b) a server subsystem for storing a database of said interface descriptions; and
(c) interface design tools providing a mean for an interface designers to create said interface description;
wherein a preferred interface description that is selected by the user is downloaded from said server subsystem to said device and used by said text entry software engine and wherein said interface descriptions created by said interface designers are uploaded and stored in said database on said server subsystem.

2. The text entry system of claim 1, wherein the system comprising a plurality of said text entry software engines each supporting different device platform.

3. The text entry system of claim 1, wherein said text entry software engine support plurality of said interface description installed in said device and enable selecting and switching between interface descriptions.

4. The text entry system of claim 1, wherein each of said interface description defines plurality of interface screens and for each interface screen said interface description defines plurality of parameters including at least one of interface screen location, size, geometry and/or appearance.

5. The text entry system of claim 1, wherein said interface description defines plurality of regions on a touch screen designated as keys and for each key defines plurality of parameters including at least one of key location, key size, key geometry, key appearance, key labels and/or key functions.

6. The text entry system of claim 5, wherein said interface description defines multi-functional keys and defines plurality of activation methods and activation functions to said multi-functional keys.

7. The text entry system of claim 1, wherein said interface description defines plurality of gesture shapes and for each of the gesture shapes defines plurality of parameters that identify the gesture and activation function associated with detection of said gesture.

8. The text entry system of claim 1, wherein said interface description defines multi segments gestures and for each segment defines plurality of parameters that identify the segment and activation function associated with detection of said gesture segment.

9. The text entry system of claim 1, wherein said system support text prediction and text completion.

10. The text entry system of claim 1, wherein said interface description format is a plurality of text and image files.

11. The text entry system of claim 1, wherein said server subsystem is a website hosting server and the services of said server are provided using web browsing interface.

12. The text entry system of claim 1, wherein said server subsystem contains for each said interface description in said database a statistics on the number of downloads, screenshots, documentation and the users rating, remarks and comments on the interface description.

13. The text entry system of claim 1, wherein said interface design tools include an applet that is downloaded from said server subsystem, runs on a web browser and enables designing and storing of a new interface description in said interface description database.

14. The text entry system of claim 1, wherein said interface design tools include a GUI base design tool wherein said design tool manipulates objects including at least key, keyboards, gestures are set, dragged and dropped, and said design tool generate said interface description according to a set of the objects created and edited by said design tool.

15. A Method for text entry for an electronic device comprising:
(a) an interface description stored on the device containing a text entry software engine that receives the interface description and condition upon said interface description realizing a text entry user interface by displaying objects on the device's screen, interrupting user input operations to text and send the text entered by the user to an applications running on said device;
(b) a database of said interface descriptions stored on a server subsystem; and
(c) interface design tools providing a mean for an interface designers to create said interface description;
wherein a preferred interface description that is selected by the user is downloaded from said database to said device and used by said text entry software engine to provide text entry user interface to the user and wherein said interface descriptions created by said interface designers are uploaded and stored in said database on said server subsystem.

16. The method of claim 15, wherein said method support plurality of said interface description installed in said device and enable selecting and switching between interface descriptions.

17. The method of claim 15, wherein each of said interface description defines plurality of interface screens and for each interface screen said interface description defines plurality of parameters including at least one of interface screen location, size, geometry and/or appearance.

18. The method of claim 15, wherein said interface description defines plurality of regions on a touch screen designated as keys and for each key defines plurality of parameters including at least one of key location, key size, key geometry, key appearance, key labels and/or key functions.

19. The method of claim 18, wherein said interface description defines multi-functional keys and defines plurality of activation methods and activation functions to said multi-functional keys.

20. The method of claim 15, wherein said interface description defines plurality of gesture shapes and for each of the gesture shapes defines plurality of parameters that identify the gesture and activation function associated with detection of said gesture.

21. The method of claim 15, wherein said interface description defines multi segments gestures and for each segment defines plurality of parameters that identify the segment and activation function associated with detection of said gesture segment.

22. The method of claim 15, wherein said method is used in conjunction with text prediction and text completion.

23. The method of claim 15, wherein said interface description format is a plurality of text and image files.

24. The method of claim 15, wherein said database contains for each said interface description statistics on the number of downloads, screenshots, documentation, user's rating and user's remarks and comments on the interface description.

25. The method of claim 15, wherein said interface description is downloaded, uploaded and rated using a website.

26. The method of claim 15, wherein said interface design tools include an applet that is downloaded and runs on a web browser and enables designing and storing of a new interface description in said interface description database.

27. The method of claim 15, wherein said interface design tools include a GUI base design tool wherein said design tool manipulates objects including at least key, keyboards and gestures that are created, set, dragged and dropped, and said design tool generates said interface description according to a set of the objects created and edited by said design tool.
